(19) United States
(12) Patent Application Publication
(10) Pub. No.: US 2010/0157349 A1
(43) Pub. Date: Jun. 24, 2010

(54) CATEGORIZED SECURE SCAN TO E-MAIL

(76) Inventor: Jiang Hong, Cupertino, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/343,182

(22) Filed: Dec. 23, 2008

(51) Int. Cl. G06F 3/12; G06F 12/14

(52) U.S. Cl. 358/1.14; 726/21

(57) ABSTRACT

A document identifier is added to print data sent to a printer connected in a network. Each page of the resulting printed document contains the document identifier, and the document identifier is associated with a security level and added to a database connected to the network. When a user later issues a scanning command to scan the document, the document identifier is obtained from the scan data and transmitted to a server. The server compares both the user and the document identifier to the database and depending on the results, either permits the scan operation to complete or aborts. If the scan operation is completed, the scan data is sent each of a set of one or more destinations that (1) are directed by the user and (2) has an appropriate security level to receive the scan data.

### TECHNICAL FIELD

This disclosure relates generally to processing electronic documents in connection with copying, printing, scanning and facsimile transmission. In particular, this disclosure relates to applying digital rights management to newly created electronic documents.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

The use of multi-function peripheral (MFP) devices has proliferated as offices have become more automated and less dependent on manual devices. MFPs have evolved from simple copying devices to document management systems. As many organizations similarly have evolved in size and complexity, these organizations require new systems and methods to organize, track, and control the dissemination of documents.

Partial approaches to handle these issues have been unsatisfactory for many reasons. One approach requires a user to manually apply some type of rights management indicator to a document after the document has been printed. Unless the user physically stands over the printing device during printing, the document could get in the hands of others, particularly if a sharing printing device is used, before application on the pages of the document of an indicator indicating a security level.

Additionally, manual application of an indicator on each document page is time-consuming and error-prone. And even if properly applied, the user is still faced with the creation and management of a document tracking database, adding still more time and possibility of error into the process.

### SUMMARY

A document identifier is added to print data sent to a printer connected in a network. Each page of the resulting printed document contains the document identifier, and the document identifier is associated with a security level and added to a database connected to the network. When a user later issues a scanning command to scan the document, the document identifier is obtained from the scan data and transmitted to a server. The server compares both user identification data and the document identifier to the database and depending on the results, either permits the scan operation to complete or aborts. If the scan operation is completed, the scan data is sent to one or more destinations that (1) are directed by the user and (2) have an appropriate security level to receive the scan data.

### BRIEF DESCRIPTION OF THE DRAWINGS

In the drawings:

FIG. 1 illustrates a routing computer and multi-function peripheral connected to a network;

FIG. 2 illustrates hardware and software components of the routing computer and multi-function peripheral connected to a network;

FIG. 3 illustrates an example of the steps involved in the creation and dissemination of an enhanced document having security features; and

FIG. 4 illustrates a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

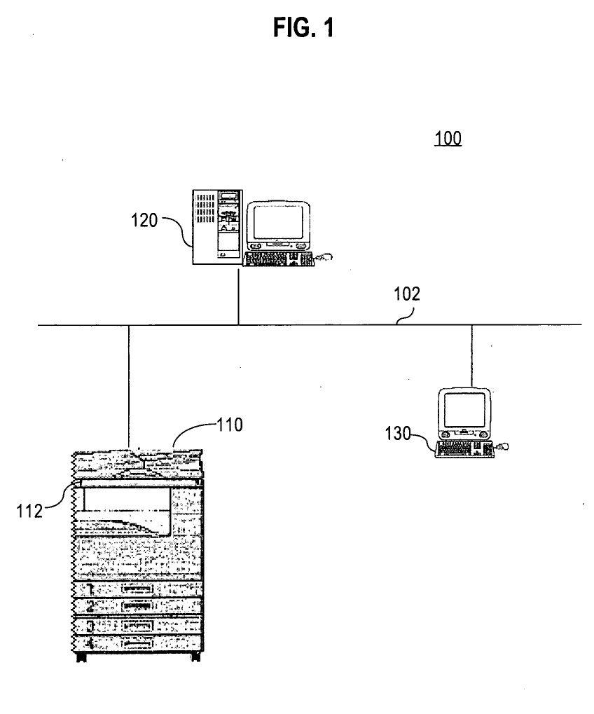

Operation of a rights management system from a user perspective is illustrated with respect to FIG. 1. FIG. 1 is a block diagram of a routing computer and multi-function peripheral connected to a network. FIG. 1 depicts system 100 in which a multi-function peripheral (MFP) 110 is connected to a network 102 to which a routing computer 120 and a user computer 130 are connected.

In an embodiment, network 102 is a local area network (LAN). In other embodiments network 102 may comprise a wide area network (WAN) configured with wide area access devices, or the network may be multiple LAN segments of a campus, or other network configurations such as the Internet.

MFP 110 typically provides functions for copying, printing, scanning and facsimile transmission of documents, but may include any subset or combination of those functions. User access to MFP 110 is provided by a user interface 112 on MFP 110. In an embodiment, user access to MFP 110 is provided by user computer 130. The user computer 130 may comprise a personal computer or server that provides an administrative interface to functions of MFP 110.

Routing computer 120 is configured to route or transfer electronic documents created using MFP 110 to network 102 and to other computers that are coupled to network 102. For example, routing computer 120 may comprise a mail server that can send electronic mail messages to user computer 130 or other computers on the network. In an embodiment, network 102 also comprises one or more storage devices such as file servers, content servers or storage area network (SAN) units, and routing computer 120 is configured to transfer electronic documents created using MFP 110 to one or more of the storage devices. In an embodiment, one routing computer 120 can manage such operations for MFP 110 and for a plurality of other MFP devices. Other functions of routing computer 120 are described further herein.

To illustrate an example, only one MFP and one user computer are shown in FIG. 1, but in actual operation network 102 may contain routing computer 120 connected to, and controlling, a plurality of MFPs and user computers. Further, MFP 110 is shown in FIG. 1 to illustrate an example, but other embodiments may use a copier, printer, scanner, fax machine, or other apparatus configured to print and scan electronic documents, and an MFP is not required. The term “MFP” as used herein may refer broadly to any such device.

In an embodiment, MFP 110, routing computer 120, and user computer 130 comprise logic that can cooperate and interoperate using network 102 to perform document processing and rights management functions for electronic documents. Example functions are now described. In an embodiment, a user is granted access to MFP 110 after providing a sign-on identification and optional parameters (such as password authentication, print job, print job number, or other data) through user computer 130. In an embodiment, the user provides sign-on identification and optional associated parameters through user interface 112 on MFP 110.

Once access to MFP 110 is granted, the user is able to perform scanning, copying, printing, and facsimile transmission operations through MFP 110. For example, upon selection of a scanning operation, the user is prompted to select the document destination either as a location in network 102, such as a folder, directory, or other repository, or a destination address selected from a list, such as an electronic mail (e-mail) address. In other embodiments, the selected location may comprise an identifier of an application program, process, or system.

In an embodiment, the document destination is pre-selected for the user. The pre-selected destination may be based on user profile information associated with the sign-on identification that the user provided.

In an embodiment, the user is also permitted to select the format of the resulting document. For example, the user might select a word-processing format, in which the scanning or facsimile receipt operation would be accompanied by application of one or more optical character recognition (OCR) programs to produce the resulting document.

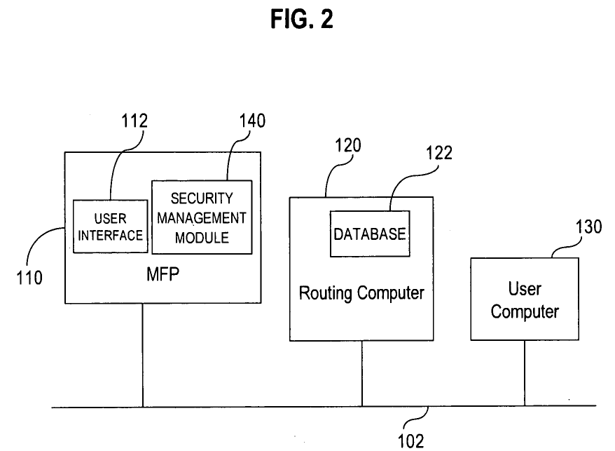

FIG. 2 is a block diagram of example hardware and software components of the routing computer and multi-function peripheral connected to a network.

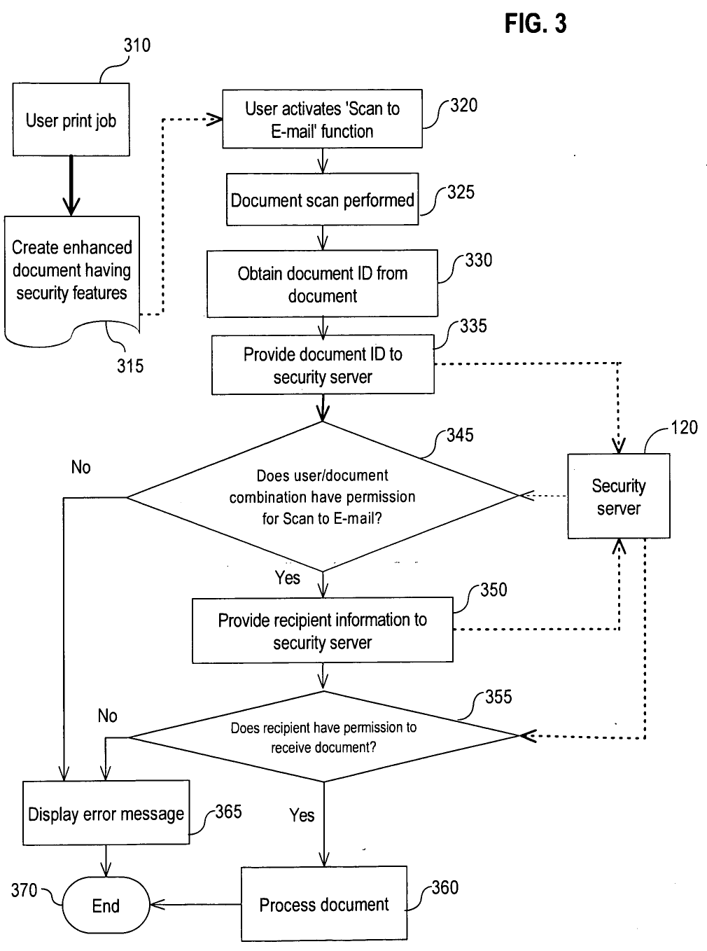

MFP 110 includes security management module 140. Security management module 140 may be implemented in firmware, hardware, software, or any combination thereof that implements the functions described herein and in connection with FIG. 3. In an embodiment, security management module 140 is implemented in software operating on MFP 110.

Routing computer 120 may be any computer having sufficient hardware and networking capacities to perform routing and rights management tasks. For example, a personal computer configured with the “ScanRouter EX Enterprise” software package commercially available from Ricoh USA, Inc., West Caldwell, N.J., and operating in a Microsoft Windows Server environment would provide a suitable platform. Routing computer 120 may comprise a server. Routing computer 120 is configured to provide rights management and may be configured to provide encryption functions. Routing computer 120 may be implemented in firmware, hardware, software, or any combination thereof that implements the functions described herein and in connection with FIG. 3. In an embodiment, routing computer 120 is implemented in one or more computer programs, processes or other software elements.

FIG. 3 illustrates an example of the steps involved in both the creation and dissemination of an enhanced document having security features. Steps 310 and 315 relate to the creation of an enhanced document having security features. The remaining steps relate to the dissemination of the enhanced document.

In step 310, the user, already having been granted access to MFP 110, issues a print command. In an embodiment, the user issues the print command from within an application program, such as a word-processing program. Alternatively, the user may issue a print command directly from MFP 110, e.g., via user interface 112 on MFP 110.

After the print command has been issued, MFP 110 receives print data, and in step 315, one or both of MFP 110 and routing computer 120 modifies the print data to add a document identifier that is printed along with the received print data. In an embodiment, the document identifier comprises alpha-numeric text. In an embodiment, the document identifier comprises bar codes. In an embodiment, the document identifier comprises a watermark or illustration.

Rules dictating content of the document identifier may be arbitrarily set by administrative personnel operating routing computer 120. In an embodiment, content of the document identifier is determined in part from the document file or metadata from the document file. In an embodiment, content of the document identifier may be determined in part from the identity of the user. In an embodiment, content of the document identifier may be determined in part from a security level associated with the document file. In an embodiment, content of the document identifier may be determined in part from a version history of the document file. In an embodiment, content of the document identifier may be determined in part from user input.

Rules dictating placement of the document identifier may be arbitrarily set by administrative personnel operating routing computer 120. In an embodiment, placement of the document identifier is determined in part from the document file or metadata from the document file; for example, the placement of the document identifier may correspond to a blank margin area appearing on each page of the printed version of the document file. In an embodiment, the angle the printed document identifier may vary relative to text in the printed version of the filed. As a non-limiting first illustrative example, suppose the document identifier selected is “SSB666-1” and is to be printed vertically in the upper right-hand margin of a 8.5″ by 11″ document at angle of 90 degrees relative to text appearing on the printed document. Thus the document identifier reads as normal text when the printed document is rotated 90 degrees, corresponding to a ‘landscape’ format.

Additionally in step 315, information from the print data is transmitted to routing computer 120. In an embodiment, one or more of the rules dictating content of the document identifier as previously described are used by routing computer 120 to form the document identifier. In an embodiment in which routing computer 120 does not form the document identifier, the document identifier is transmitted to routing computer 120.

During step 315, routing computer 120 places one or more entries in database 122. The entries correspond to the document identifier and a security level associated with the document. In an embodiment, one or more of the following are entered into database 122: a copy of the document file, metadata from the document file (such as one or more of creation date, author(s), keyword(s), or summary), and the print data. In an embodiment, prior versions of the document file, if existing, are compared to the current document file, with adjustment to the document identifier so that each of multiple versions of the document file may be identified.

As further described below, database 122 also includes entries corresponding to a destination and a security level associated with the destination. As explained above, a destination may comprise a location in network 102, such as a folder, directory, or other repository, or a destination address selected from a list, such as an electronic mail (e-mail) address. For example, a destination address could be designated by a user name, such as “John,” which would refer to one or more e-mail addresses maintained by the user “John.”

In an embodiment, database 122 includes a first table having entries corresponding to the document identifier, the security level associated with the document, and a pointer to (or the contents of) the document file. In this embodiment, database 122 also includes a second table having entries corresponding to a destination (such as a user) and the security level associated with each destination. For the illustrative examples, the following two tables are referenced:

TABLE 1

| Document ID | Security level | Copy of file |
|---|---|---|
| SSB666-1 | Internal | (pointer to or copy of file with |
| | | ID SSB666-1 obtained from |
| | | scan) |
| SSD11-7 | Classified | (pointer to or copy of file with |
| | | ID SSD11-7 obtained from |
| | | scan) |
| AB35-55 | Public | (pointer to or copy of file with |
| | | ID AB35-55 obtained from |
| | | scan) |

TABLE 2

| User Name | Destination | Security level |
|---|---|---|
| John | John@company.com | Internal |
| Jack | Server C: Folder A/Scan Doc/ | Internal |
| Bob | Computer A: Bob/Scan to | Classified |
| | mail/ | |
| Frank | J.Frank@publicplace.com | Public |

In this first illustrative example, documents may possess three security levels: “Public,” “Internal,” and “Classified.” Then the following are entered into database 122: (1) an entry “SSB666-1;” (2) a security level of “Internal;” and (3) a pointer to (or copy of) the document file. (See the first entry of Table 1 above.)

Finally, in step 315, modified print data including the document identifier is printed by MFP 110. Depending on the amount of user input desired regarding the formation of the document identifier, the application of the document identifier may be performed transparently to the user. Upon completion of step 315, the user possesses an enhanced printed document having valuable security features. The remainder of FIG. 3 details the steps performed by security management module 140 once these security features have been activated.

At some point in time after creation of the enhanced printed document (the “printed document”), a holder of a copy of the printed document desires to create an electronic copy using one of the MFPs connected as part of the network illustrated in FIG. 2. The document holder (referred to below as the “user”) is granted access to MFP 110 after providing a sign-on identification, either through user interface 112 on MFP 110, through user computer 130, or through other means (such as through an RFID tag). In step 320, this document holder (referred to below as the “user”) activates a ‘Scan to E-mail’ function of MFP 110.

In the first illustrative example, a user named “Jack” activates the ‘Scan to E-mail’ function using the printed document created above in step 315. Jack has a security level of Internal (see the second entry of Table 2) and the printed document has a security level of Internal (see the first entry of Table 1). (Note however, that any user in the network could have created the printed document that Jack now possesses and wishes to distribute.)

The user is prompted to select one or more destinations for the document to be scanned either as location in network 102, such as a folder, directory, or other repository, or a destination address selected from a list, such as an electronic mail (e-mail) address. In other embodiments, the selected location may comprise an identifier of an application program, process, or system. In the first illustrative example, Jack selects the individuals “John,” “Bob,” and “Frank” as the intended recipients of the scanned document to be sent via e-mail.

In step 325, the printed document is scanned by MFP 110. In step 330, a scanned document identifier is obtained from the printed document. In an embodiment, MFP 110 performs optical character recognition of the printed document to obtain the scanned document identifier. In an embodiment, MFP 110 performs a bar code scan of the printed document to obtain the scanned document identifier. In an embodiment, MFP 110 obtains a scanned document identifier from any number of pages of the document. In an embodiment, MFP 110 obtains a scanned document identifier from each page of the printed document. In an embodiment, MFP 110 compares the resulting set of scanned document identifiers and reports an error message should one or more scanned document identifiers not match others in the set, possibly indicating pages from different printed documents have been interleaved and scanned together.

In the first illustrative example, MFP 110 obtains the scanned document identifier “SSB666-1” from each page of the printed document.

In step 335, the scanned document identifier is transmitted to routing computer 120 for a comparison with the set of document identifiers residing in the database 122 of routing computer 120. Once a match is located between the scanned document identifier and the set of document identifiers, the corresponding security level associated with the scanned document is located. Absent a match between the scanned document identifier and the set of document identifiers, the process may associate a default security level to the scanned document. In an embodiment, the process terminates with an error message; such a termination is not shown in FIG. 3.

In the first illustrative example, the scanned document identifier “SSB666-1” is located in the database and the corresponding security level of Internal is located.

In step 345, the user permission level based on the identity of the user is compared to the security level of the scanned document. Should the user permission level not allow the user to process or access the scanned document, the process terminates with an error message in step 365. If the user possesses a sufficient permission level to perform the ‘Scan to E-mail’ function, in step 350 the destination information previously selected by the user is forwarded to routing computer 120.

In step 355, the security level of the destination is compared to the security level of the scanned document, and if the security level of the destination has sufficient permission to receive the scanned document, the scanned document is processed and forwarded to the destination in step 360. Should the destination lack the requisite security level, the scanned document is not forwarded to the destination, and an error message is displayed in step 365. Each destination is processed in this manner.

Thus to complete the first illustrative example, suppose (as illustrated in Table 2 above) Bob has a security level of Classified, John has a security level of Internal, and Frank has a security level of Public. Then Jack's activation of the ‘Scan to E-mail’ feature has the following results: (1) the scanned document (having identifier “SSB666-1”) is transmitted to Bob, as he has a security level of Classified and is entitled to receive all documents; the scanned document is transmitted to John, as both he and the scanned document have a security level of Internal; (2) the scanned document is not transmitted to Frank, as his security level of Public does not permit him to receive scanned documents having a security level of Internal.

In a non-limiting second illustrative example, all information is the same as in the first illustrative example, except now the printed document Jack wishes to distribute has a security level of Classified. In this second illustrative example, while the scan would occur, neither Jack nor the destinations would receive the scanned document, as Jack's security level of Internal is insufficient to permit Jack to receive a scanned version of a printed document having a security level of Classified.

Finally, in a non-limiting third illustrative example, all information is the same as in the first illustrative example, except now: (1) the printed document Jack wishes to distribute has a security level of Public, and (2) the destinations selected by Jack are Bob and Frank. In this third illustrative example, both Bob and Frank would receive the scanned document, as each of Jack, Bob, and Frank has a security level of at least Public.

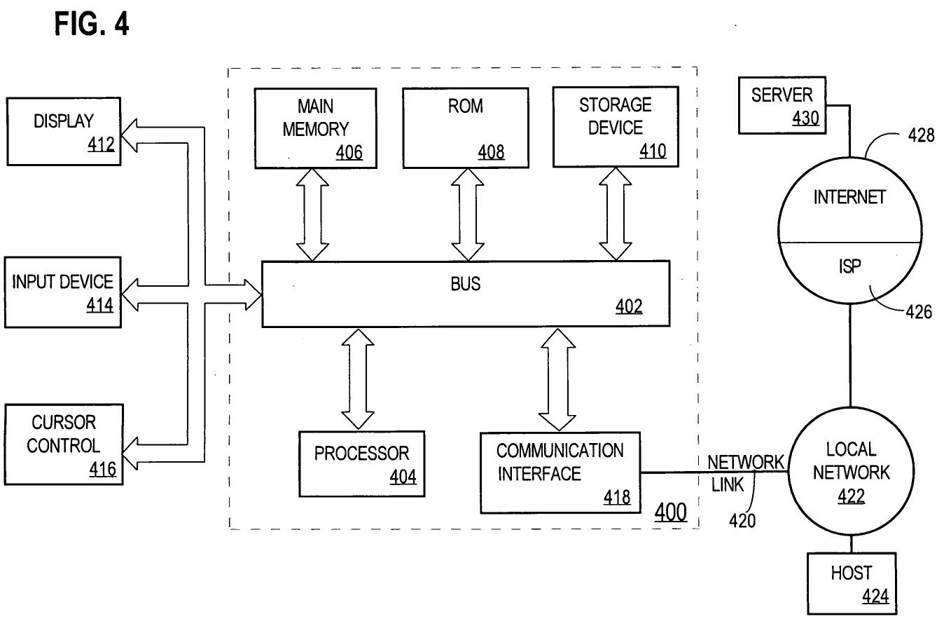

The approach described herein for performing rights management on scanned documents or documents received via facsimile may be implemented on any type of computing platform or architecture. To illustrate an example, FIG. 4 is a block diagram that depicts an example computer system 400 upon which embodiments of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 400, various computer-readable media are involved, for example, in providing instructions to processor 404 for execution. Such a medium may take many forms, including but not limited to, tangible data storage media such as non-volatile media and volatile media. Non-volatile media includes, for example, optical or magnetic disks, such as storage device 410. Volatile media includes dynamic memory, such as main memory 406. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage device 410, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A device comprising:
a network interface configured to transmit data to one or more networks;
a security management module operatively connected to the network interface, and configured to:
examine scan data that represents a printed document scanned by the device under command of a user, wherein the user is identified by a user identifier;
obtain a document identifier from the scan data;
transmit, to a server, the user identifier and the document identifier;
receive, from the server, authorization data indicating whether to allow further processing of the scan data; and
prevent further processing if the authorization data does not allow further processing of the scan data.

2. The device of claim 1, wherein obtaining a document identifier from the scan data is performed using one or both of: optical character recognition, and bar code recognition.

3. The device of claim 1, wherein the document identifier is added to a physical copy of the document during or after creation of the physical copy of the document.

4. The device of claim 1, wherein receiving authorization data further includes:
comparing the document identifier to a list of documents and corresponding document security levels;
if the document identifier matches a document in the list of documents, then associating the security level of the matched document to the scan data;
if the document identifier does not match any document in the list of documents, then associating a default security level to the scan data;
obtaining a user permission level based on the user identifier;
comparing the associated security level of the scan data to the user permission level;
if the user permission level does not allow access to the scan data, then setting the authorization data to deny further processing of the scan data; and
if the user permission level allows access to the scan data, then setting the authorization data to allow further processing of the scan data.

5. A computer-readable storage medium storing instructions for scanning printed documents, wherein execution of the instructions by one or more processors configures the one or more processors to:
transmit data to one or more networks over a network interface;
examine scan data that represents a printed document scanned under command of a user, wherein the user is identified by a user identifier;
obtain a document identifier from the scan data;
transmit, to a server, the user identifier and the document identifier;
receive, from the server, authorization data indicating whether to allow further processing of the scan data; and
prevent further processing if the authorization data does not allow further processing of the scan data.

6. The computer-readable storage medium of claim 5, wherein obtaining a document identifier from the scan data is performed using one or both of: optical character recognition, and bar code recognition.

7. The computer-readable storage medium of claim 5, wherein the document identifier is added to a physical copy of the document during or after creation of the physical copy of the document.

8. The computer-readable storage medium of claim 5, wherein receiving authorization data further includes:
comparing the document identifier to a list of documents and corresponding document security levels;
if the document identifier matches a document in the list of documents, then associating the security level of the matched document to the scan data;
if the document identifier does not match any document in the list of documents, then associating a default security level to the scan data;
obtaining a user permission level based on the user identifier;
comparing the associated security level of the scan data to the user permission level;
if the user permission level does not allow access to the scan data, then setting the authorization data to deny further processing of the scan data; and
if the user permission level allows access to the scan data, then setting the authorization data to allow further processing of the scan data.

9. A device comprising:
a network interface configured to transmit data to one or more networks;
a security management module operatively connected to the network interface, and configured to:
examine scan data that represents a printed document scanned by the device;
obtain a document identifier from the scan data;
transmit, to a server, a destination address and the document identifier;
receive, from the server, authorization data indicating whether to transmit the scan data to the destination address; and
deny transmitting the scan data to the destination address if the authorization data does not allow transmission.

10. The device of claim 9, wherein obtaining a document identifier from the scan data is performed using one or both of: optical character recognition, and bar code recognition.

11. The device of claim 9, wherein the document identifier is added to a physical copy of the document during or after creation of the physical copy of the document.

12. The device of claim 9, wherein receiving authorization data includes:
comparing a security level associated with the document identifier to a permission level associated with the destination address;
if the security level associated with the document identifier allows the destination address access to the scan data, then setting the authorization data to allow transmitting the scan data to the destination address; and
if the security level associated with the document identifier does not allow the destination address access to the data, then setting the authorization data to deny transmitting the scan data to the destination address.
